(19) United States
(12) Patent Application Publication
(10) Pub. No.: US 2018/0209371 A1
(43) Pub. Date: Jul. 26, 2018

(54) METHOD FOR CONTROLLING THE RAIL PRESSURE IN AN INJECTION SYSTEM

(71) Applicant: CONTINENTAL AUTOMOTIVE GMBH, Hannover (DE)

(72) Inventors: Andreas Bodensteiner, Lappersdorf (DE); Thomas Kraft, Obertraubling (DE); Walter Sassler, Regensburg (DE)

(73) Assignee: CONTINENTAL AUTOMOTIVE GMBH, Hannover (DE)

(21) Appl. No.: 15/928,612

(22) Filed: Mar. 22, 2018

Related U.S. Application Data
(63) Continuation of application No. PCT/EP2016/071896, filed on Sep. 15, 2016.

(30) Foreign Application Priority Data
Sep. 23, 2015 (DE) 10 2015 218 258.4

(51) Int. Cl. F02D 41/38; F02D 41/00; F02D 41/06

(52) U.S. Cl. CPC F02D 41/3845; F02D 41/009; F02D 2250/31; F02D 2200/02; F02D 41/062

(57) ABSTRACT

A method for regulating the rail pressure in an injection system of a motor vehicle is described. For the purpose of regulating the rail pressure, a high-pressure pump, which is provided with a digital inlet valve, is actuated, wherein the digital inlet valve is activated such that it is matched to the delivery and suction phase physically present. In this way, it is possible for pressure regulation to be achieved by way of a digital valve even for transmission ratios at which the pump does not have exactly a multiple of delivery and suction phases during two engine cycles.

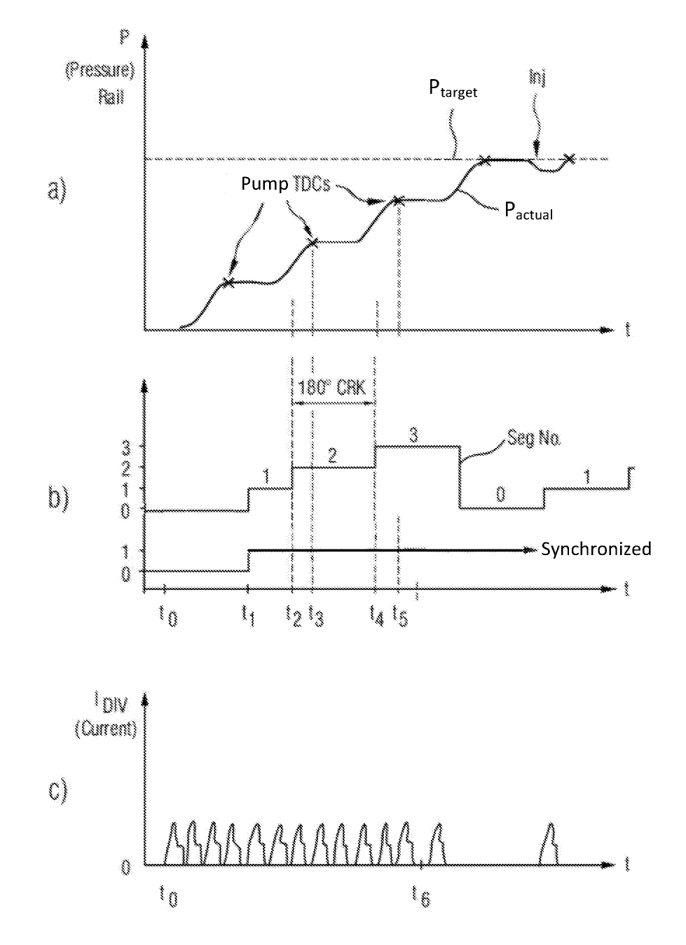

### CROSS REFERENCE TO RELATED APPLICATIONS

This application is a continuation of International application No. PCT/EP2016/071896, filed Sep. 15, 2016, which claims priority to German application No. 10 2015 218 258.4, filed on Sep. 23, 2015, each of which is hereby incorporated by reference herein in its entirety.

### FIELD OF INVENTION

The present invention relates to a method for regulating the rail pressure in an injection system of a motor vehicle by actuation of a high-pressure pump which is provided with a digital inlet valve.

### BACKGROUND

In a high-pressure injection system, the fuel pressure is always regulated to the target pressure. For reasons of regulation quality, specific transmission ratios between an engine and a pump should always be selected for the regulation of the pressure by way of digital inlet valves. Such transmission ratios include for example transmission ratios of a single-piston pump (double cam) to an engine of 1:1 (one working cycle of the pump=one working cycle of the engine) or asynchronous settings which, however, correspond to exactly 720° CRK (crankshaft angle, two engine cycles) for the pump (delivery and suction stroke). For example, Np:Nm=1:2, 2:1, or 3:2, depending on the number of pump cams (in this case, for example, two).

However, transmission ratios which cannot achieve a multiple of delivery and suction phases within 720° CRK for the pump movement are currently not able to be regulated by way of digital valves without performance losses (for example Np:Nm=2:3). Here, the single piston pump realizes only 480° at 720° CRK in the case of a double cam. The delivery and suction phases of the pump do not correspond in an exact manner. The reference (the spacing) between the pump TDC (top dead center of pump) and the engine TDC (top dead center of engine) shifts (for example 135° CRK in the second working cycle).

This problem is currently able to be solved in the case of a single piston pump by way of a triple cam (depending on the transmission ratio pump:engine). However, this means a change of hardware at the pump. Another measure is a change of the transmission ratio between the pump and the engine, this however leading to relatively large, costly changes to the engine in some cases. It would also be possible for an additional sensor to be provided at the pump, which is however associated with additional costs.

### DESCRIPTION

Embodiments of the present invention are based on the object of providing a method of the type described in the introduction which allows particularly exact regulation of the rail pressure despite an asynchronous transmission ratio between the pump and the engine.

Embodiments of the invention include a method of the specified type which includes the following steps:
carrying out blind energization of the digital inlet valve for the purpose of opening and closing the valve;
recording the pressure signal from the rail during the blind energization and determining from this a top dead center of the pump stroke (pump TDC);
approximately determining a crankshaft position for the determined pump TDC;
selecting the correct reference (spacing) between the pump TDC and the top dead center of the engine (engine TDC) corresponding to the exact physical relationship resulting from the transmission ratio Np:Nm by using the approximately determined crankshaft position of the pump;
carrying out switching reduction by selecting only those active pump TDCs which correspond to the selected correct reference; and
carrying out activation of the digital inlet valve solely on the basis of the selected pump TDCs, with ending of the blind energization.
   Here, the following meanings apply: Np=rotational speed of pump, and Nm=rotational speed of engine.

In the method according to the example embodiments, in an engine starting phase, the digital inlet valve is closed at specific time intervals by way of a specific pulse. Since neither pump TDC nor the engine TDC are known at this point in time, the blind energization has to be carried out. This has the effect that the digital inlet valve is closed repeatedly. In an upward piston movement in which the digital inlet valve has just been closed electrically, a pressure build-up occurs in the piston chamber and then in the rail too. The digital inlet valve may no longer open during the upward piston movement (pressure build-up phase) since it is kept closed hydraulically. This type of energization is carried out until successful detection of the top dead centers of the pump stroke (pump TDCs) occurs.

Here, the signal from the rail is recorded during the blind energization, such as in a highly resolved manner with, for example, a sampling rate of 1 ms. In the pressure signal, the respective pump TDCs may be detected in the respective engine segment. For this pressure signal, a corresponding crankshaft position (CRK value) is also obtained. After each delivery phase, the pump TDC is detected as soon as the pressure no longer rises for, for example, 40° CRK. This allows precisely one crankshaft position to be assigned to the pump TDC.

It is then possible for the correct reference between the pump TDC and the engine TDC to be selected from the physically possible, matched top dead centers (TDCs).

Furthermore, switching reduction is carried out in that only those active pump TDCs which correspond to the selected correct reference are selected. Finally, synchronous activation of the digital inlet valve solely on the basis of the selected pump TDCs, with ending of the blind energization, is carried out.

In the switching reduction carried out according to the example embodiments, for example only every third delivery pulse is carried out. Remaining in this case is only that delivery pulse with which the activation pulse travel is matched to the mechanical pump movement. As a result of the switching reduction, it is then also possible for the times which have become free to be allotted to the actual remaining pulse. It is thus possible for the remaining pulse to use the full physical cam shape in order to be able to deliver all delivery quantities (from full to small) for the high-pressure system.

The method according to the example embodiments thus allows pressure regulation by way of digital valves even for transmission ratios at which the pump does not have exactly a multiple of delivery and suction phases at a crank angle of 720° (CRK). With the method according to the example embodiments, it is possible to avoid costly hardware changes (engine, pump, and sensor).

In a refinement of the method according to the example embodiments, the selected correct reference is checked for plausibility in at least one following engine segment, and a switch to activation of the digital inlet valve which is matched to the physical pump movement is then realized. The blind energization is then ended.

The number of the possible delivery pulses of the digital inlet valve is increased until one of the resulting pump TDCs coincides with the physical pump TDC.

The method according to the example embodiments shall be explained. The single FIGURE shows at the top (a) the pressure profile in the rail, in the middle (b) an internal software variable for engine synchronicity and at the bottom (c) the current profile at the digital inlet valve.

The example embodiment illustrated here relates to a method for regulating the rail pressure in an injection system of a motor vehicle by actuation of a high-pressure pump which is provided with a digital inlet valve. In an engine starting phase, the digital inlet valve is closed by way of multiple pulses from point in time to onward. This blind energization is carried out until successful detection of the pump TDCs (point in time t₆).

From point in time t₁ onward, the engine control unit has detected a synchronous state and thus knows the engine segment where one is. An engine segment change (t₂ or t₃) then has a fixed crankshaft reference with respect to the top dead center of the cylinder (TDC cyl 0) for the injection. The pressure signal is recorded in a highly resolved manner between to and t6, for example with a sampling rate of 1 ms. In the pressure signal, the pump TDC may be detected in the respective engine segment between t₁ and t₆. This is illustrated in the top part (a) of the FIGURE. From t₁ onward, the pump TDC is detected after each delivery phase as soon as the pressure no longer rises for, for example, 40° CRK. This allows precisely one crankshaft position to be assigned to the pump TDC. Since corresponding reference angles are available, the correct angle may then be determined.

The detection may also be checked for plausibility in the following segment (from t₄ onward, segment 3). Following a successful plausibility check, it is possible from t₆ onward for a complete switch to activation of the digital inlet valve, which is matched to the physical pump movement, to be realized. The blind energization is ended.

In the FIGURE, the following points in time have the following meanings:
t₀=engine start,
t₁=engine synchronized,
t₂ and t₄=engine segment change,
t₃ and t₅=pump TDCs detectable in the pressure signal, and
t₆=switchover to segment-synchronized activation.

The foregoing embodiments have been shown and described for the purposes of illustrating the structural and functional principles of the present invention, as well as illustrating the methods of employing the embodiments and are subject to change without departing from such principles. Therefore, this invention includes all modifications encompassed within the scope of the following claims.

1. A method for regulating rail pressure in an injection system of a motor vehicle engine having a crankshaft, by actuation of a high-pressure pump which is provided with a digital inlet valve, comprising:
carrying out blind energization of the digital inlet valve for opening and closing the valve;
recording a pressure signal from the rail during the blind energization and determining therefrom a top dead center of a pump stroke of the high-pressure pump;
approximately determining a crankshaft position for the determined top dead center of the pump stroke;
selecting a correct reference between the top dead center of the pump stroke and a top dead center of the engine corresponding to a physical relationship resulting from a transmission ratio Np:Nm, wherein NP is a rotational speed of the pump and Nm is a rotational speed of the engine, by using the approximately determined crankshaft position of the pump;
carrying out switching reduction by selecting only those active top dead centers of the pump stroke which correspond to the selected correct reference; and
carrying out activation of the digital inlet valve solely on the basis of the selected top dead centers of the pump stroke, with ending of the blind energization.

2. The method as claimed in claim 1, wherein the selected correct reference is checked for plausibility in at least one following engine segment, and a switch to activation of the digital inlet valve which is matched to the physical pump movement is then realized.

3. The method as claimed in claim 2, further comprising increasing a number of possible delivery pulses of the digital inlet valve until one of the resulting top dead centers of the pump stroke coincides with a physical top dead center of the pump stroke.

4. The method as claimed in claim 1, further comprising increasing a number of possible delivery pulses of the digital inlet valve until one of the resulting top dead centers of the pump stroke coincides with a physical top dead center of the pump stroke.

5. The method of claim 1, further comprising checking the selected correct reference for plausibility in at least one following engine segment, and synchronously activating the digital inlet valve to the physical pump movement.

6. A method for regulating rail pressure of a fuel rail in an injection system of a motor vehicle engine having a crankshaft, the injection system including a high-pressure pump having a digital inlet valve, the regulating by actuation of the high-pressure pump, comprising:
performing blind energization of the digital inlet valve for opening and closing the valve;
recording a pressure signal from the fuel rail during the blind energization and determining from the pressure signal a top dead center of a pump stroke of the pump;
approximately determining a crankshaft position for the determined top dead center of the pump stroke;
selecting a correct reference between the top dead center of the pump stroke and a top dead center of the engine corresponding to a physical relationship resulting from a transmission ratio of a rotational speed of the pump to a rotational speed of the engine, by using the approximately determined crankshaft position of the pump;
carrying out switching reduction by selecting only those active plural top dead centers of the pump stroke which correspond to the selected correct reference; and
carrying out activation of the digital inlet valve on the basis of the selected active top dead centers of the pump stroke, and ending the blind energization.

7. The method of claim 6, wherein carrying out activation of the digital inlet valve is performed solely based on the selected active plural top dead centers of the pump stroke.

8. The method of claim 6, further comprising checking the selected correct reference for plausibility in at least one following engine segment, and matching activation of the digital inlet valve with physical pump movement.

9. The method as claimed in claim 8, further comprising increasing a number of possible delivery pulses of the digital inlet valve until one of the resulting top dead centers of the pump stroke coincides with a physical top dead center of the pump stroke.

10. The method as claimed in claim 6, further comprising increasing a number of possible delivery pulses of the digital inlet valve until one of the resulting top dead centers of the pump stroke coincides with a physical top dead center of the pump stroke.
